(19) United States
(12) Patent Application Publication
(10) Pub. No.: US 2022/0182385 A1
(43) Pub. Date: Jun. 9, 2022

(54) CROSS-ENDPOINT ENTERPRISE APPLICATION AUTHORIZATION AND MANAGEMENT

(71) Applicant: Citrix Systems, Inc., Ft. Lauderdale, FL (US)

(72) Inventors: Anjaneya Padmakar Akondi, Coral Springs, FL (US); Sumana Gandur Satyanarayana, Pompano Beach, FL (US); Liming Wang, Coconut Creek, FL (US); Raul Planas, Miami, FL (US)

(73) Assignee: Citrix Systems, Inc., Ft. Lauderdale, FL (US)

(21) Appl. No.: 17/116,804

(22) Filed: Dec. 9, 2020

(51) Int. Cl. H04L 29/06; G06F 3/06

(52) U.S. Cl. CPC H04L 63/10; G06F 3/0604; G06F 3/0652; H04L 63/083; G06F 3/0644; H04L 63/20; H04L 63/0853; G06F 3/0679

(57) ABSTRACT

A computer system to authorize a first endpoint to access enterprise digital resources is provided. The computer system includes the first endpoint, a second endpoint, and an endpoint management service being executed in a server. The endpoint management service communicates with the first endpoint via the second endpoint. For example, the endpoint management service receives authentication credentials from the first endpoint via the second endpoint. Similarly, the endpoint management service, upon verification of the authentication credentials, transmits an authorization token to the first endpoint via the second endpoint. The first endpoint, upon receiving and deploying the authorization token, can execute enterprise managed application programs and can access enterprise digital resources. In some examples, both the first and second endpoints are owned and/or used by a same user.

### BACKGROUND

Increasingly, employees of organizations and enterprises are using a plethora of mobile devices, such as smart phones, tablet computers, and other mobile computing devices. The employees are also using these devices to access organizational digital resources, such as work email and/or other organizational digital resources, and working remotely from home. As these devices continue to grow in popularity, the organizations aim to place certain controls on how these devices can be used for work related purposes, and what organizational digital resources these devices can access.

### SUMMARY

In at least one example, a computer system is provided. The computer system includes a second endpoint configured to communicate with a first endpoint distinct from the second endpoint. The second endpoint includes a network interface, a memory, and one or more processors coupled to the memory and the network interface. The one or more processors are configured to receive, from an endpoint management service via the network interface, authorization information authorizing the first endpoint to access digital resources controlled by the endpoint management service, and transmit the authorization information to the first endpoint to enable the first endpoint to access the digital resources based on the authorization information.

Examples of the computer system can include one or more of the following features.

In the computer system, the authorization information can include an authorization token usable by the first endpoint to access the digital resources, and one or more policies dictating one or more corresponding rules associated with accessing the digital resources. The one or more processors can be further configured to receive a user input to prevent the first endpoint from accessing the digital resources; and in response to the user input, transmit one or more of a first request to the endpoint management service, requesting the endpoint management service to mark the authorization token as being invalid, thereby preventing the first endpoint from accessing the digital resources, or a second request to the first endpoint, requesting the first endpoint to delete the authorization token and/or to wipe out application data associated with one or more application programs installed in the first endpoint.

In the computer system, the one or more processors can be further configured to identify a deviation in communications between the second endpoint and the first endpoint; and in response to identification of the deviation, request the endpoint management service to mark the authorization token as being invalid, thereby preventing the first endpoint from accessing the digital resources. The one or more processors can be further configured to transmit the authorization information to the first endpoint over a personal area network or a local area network. The one or more processors can be further configured to receive, from the first endpoint, an indication that an application program has been installed in the first endpoint, and a first request for the authorization information, the first request comprising authentication credentials that includes one or both of a user identifier or a password; and transmit, to the endpoint management service, a second request for the authorization information, the second request including the authentication credentials, wherein the second endpoint receives the authorization information from the endpoint management service in response to the second request.

In the computer system, the network interface can be a first network interface, the memory can be a first memory, the one or more processors can be first one or more processors, and the computer system can further include the first endpoint. The first endpoint can include a second network interface; a second memory; and one or more second processors coupled to the second memory and the second network interface. The one or more second processors being configured to install an application program in the first endpoint, transmit, to the second endpoint, a request for the authorization information, to enable the application program to access the digital resources, receive, from the second endpoint, the authorization information, and execute the application program, and access, using the application program, the digital resources, based on the authorization information. The authorization information can include an authorization token usable by the first endpoint to access the digital resources, and one or more policies dictating one or more corresponding rules associated with accessing the digital resources; and the one or more second processors are further configured to store the authorization token and the one or more policies in the second memory, and in response to a deviation in communication with the second endpoint and/or in response to a request from the second endpoint, delete the authorization token and/or wipe out application data associated with the application program.

In at least one example, a first endpoint is provided. The first endpoint includes a network interface; a memory; and one or more processors coupled to the memory and the network interface, the one or more processors configured to install an application program in the first endpoint; request, to an endpoint management service via a second endpoint, for an authorization token; receive, from the endpoint management service via the second endpoint, the authorization token; and execute the application program, in response to receiving the authorization token.

Examples of the first endpoint can include one or more of the following features.

In the first endpoint, the one or more processors can be further configured to execute a first cross-endpoint management service that processes the authorization token; the authorization token can be received from a second cross-endpoint management service being executed in the second endpoint; and, during reception of the authorization token, a same user credential can be used to log into both of the first cross-endpoint management service and the second cross-endpoint management service. The first endpoint can transmit the request for the authorization token to the second endpoint and can receive the authorization token from the second endpoint over a personal area network or a local area network. The one or more processors can be further configured to transmit another request to an authentication service to access enterprise digital resources, the other request including the authorization token; and in response to the authentication service successfully verifying the authorization token, receive authorization to access the enterprise digital resources.

The first endpoint can further include a non-volatile storage logically partitioned in a first section and a second section. In the first endpoint, application data associated with the application program and the authorization token can be stored in the first section. Personal user data can be stored in the second section. The one or more processors can be further configured to receive, from the second endpoint, instructions to revoke authorization to execute the application program, wherein the instructions to revoke originates either (i) in the endpoint management service and transmitted via the second endpoint, or (ii) in the second endpoint, and in response to the instructions to revoke, to delete the authorization token and/or wipe out the application data from the first section of the non-volatile storage, without deleting any personal user data from the second section of the non-volatile storage.

In the first endpoint, application data associated with the application program and the authorization token can be stored in the first section. The personal user data can be stored in the second section. The one or more processors can be further configured to detect a failure of the first endpoint to communicate with the second endpoint for at least a threshold period of time, and in response to the failure to communicate for at least the threshold period of time, delete the authorization token and/or wipe out the application data from the first section of the non-volatile storage, without deleting any personal user data from the second section of the non-volatile storage.

In at least one example, a method is provided. The method includes receiving, by a second endpoint and from an endpoint management service, an authorization token intended for a first endpoint; and transmitting, by a second cross-endpoint management service being executed in the second endpoint, the authorization token to a first cross-endpoint management service being executed in the first endpoint, to facilitate the first endpoint to access digital resources based on the authorization token, wherein during transmission of the authorization token, a same user credential is used to log into both of the first cross-endpoint management service and the second cross-endpoint management service.

Examples of the method can include one or more of the following features.

The method can further include receiving, from the first endpoint, a request for authorization, the request including authorization credentials; and transmitting the request, along with the authorization credentials, to the endpoint management service, wherein the authorization token is received by the second endpoint from the endpoint management service, in response to transmitting the request to the endpoint management service. The method can further include receiving a user input to revoke authorization of the first endpoint to access the digital resources; and in response to the user input, transmitting by the second endpoint and to the endpoint management service, a request to revoke the authorization of the first endpoint. The method can further include transmitting, in response to the user input and by the second endpoint to the first endpoint, another request to delete the authorization token and/or to perform a wipe out process at the first endpoint. The method can further include identifying, by the second cross-endpoint management service of the second endpoint, a deviation in communications with the first cross-endpoint management service of the first endpoint; and in response to identifying the deviation in communications, transmitting, by the second endpoint and to the endpoint management service, a request to revoke the authorization of the first endpoint. The method can further include receiving, by the second endpoint, a request from the endpoint management service, to revoke authorization of the first endpoint to access the digital resources; and in response to the request, transmitting, by the second endpoint and to the first endpoint, another request to delete the authorization token and/or to perform a wipe out process at the first endpoint.

Still other aspects, examples and advantages of these aspects and examples, are discussed in detail below. Moreover, it is to be understood that both the foregoing information and the following detailed description are merely illustrative examples of various aspects and features and are intended to provide an overview or framework for understanding the nature and character of the claimed aspects and examples. Any example or feature disclosed herein can be combined with any other example or feature. References to different examples are not necessarily mutually exclusive and are intended to indicate that a particular feature, structure, or characteristic described in connection with the example can be included in at least one example. Thus, terms like “other” and “another” when referring to the examples described herein are not intended to communicate any sort of exclusivity or grouping of features but rather are included to promote readability.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and are incorporated in and constitute a part of this specification but are not intended as a definition of the limits of any particular example. The drawings, together with the remainder of the specification, serve to explain principles and operations of the described and claimed aspects. In the figures, each identical or nearly identical component that is illustrated in various figures is represented by a like numeral. For purposes of clarity, not every component may be labeled in every figure.

FIG. 1 is a block diagram schematically illustrating an architecture of an enhanced endpoint management system, in accordance with an example of the present disclosure.

FIG. 2 is a flow diagram of an enhanced endpoint management process, in accordance with an example of the present disclosure.

FIG. 3 is a sequence diagram that illustrates an enhanced endpoint management process, in accordance with an example of the present disclosure.

FIGS. 4A-4D are sequence diagrams that illustrate example authorization revocation processes, in accordance with an example of the present disclosure.

FIG. 5 is a block diagram of a computing platform configured to implement various enhanced endpoint management systems and processes, in accordance with an example of the present disclosure.

### DETAILED DESCRIPTION

As discussed herein previously, increasingly, employees of enterprises or organizations are using a plethora of mobile devices, such as smart phones, tablet computers, and other mobile computing devices, for work related purposes and to access organizational digital resources. Enterprises employ various endpoint management services that aim to manage the manner in which these devices can safely and securely access enterprise resources. Enterprise level Mobile Application Management (MAM) and Mobile Device Management (MDM) are examples of such enterprise level endpoint management services for management of endpoints that execute enterprise application and access enterprise digital resources. Both MAM and MDM have been widely adopted. MDM is typically a deployment of a combination of on-device applications and configurations, corporate policies and certificates, and backend infrastructure. MDM is used by network/information technology (IT) administrators to monitor, manage, and secure corporate or personally-owned mobile devices. MAM software, on the other hand, allows network/IT administrators to apply and enforce corporate policies on mobile apps and limit the sharing of corporate data among apps within mobile devices owned by employees. MAM also enables the separation of business apps and data from personal content on the same device. Thus, while MDM primarily facilitates device level control of mobile devices by the network/IT administrators, MAM is typically geared towards application level control of mobile devices by the network/IT administrators. There are many other endpoint management services (e.g., in addition to, or instead of, MDM and/or MAM) to secure enterprise data and applications, such as Enterprise Mobility Management (EMM) and Unified Endpoint Management (UEM), which provide additional functionality for endpoint management. An endpoint management service, such as any of those described above, provide network/IT administrators with at least some degree of control over endpoints.

For purposes of this disclosure, an “endpoint” is a computer device, such as a desktop computer, a laptop computer, a smart phone, a tablet, or another appropriate user-accessible computer device, which is used by an end user, and not by network/IT administrators responsible for enforcing IT security policies across an enterprise. An endpoint is a “user-accessible” computer device, where the term “user-accessible” is used herein to emphasize that the endpoints are used by end users, and not by the network/IT administrators for managing and/or configuring security settings. For example, an endpoint can have various application programs, such as email applications, web browsing applications, software-as-a-service (SaaS) applications, native applications, and/or the like. Devices such as gateway servers, routers, modems, authentication servers, endpoint management servers, and/or various network or security devices are not used by end users, and cannot be deemed as endpoints.

Often times, a user owns and/or uses multiple such endpoint devices, which are simply referred to herein as endpoints. To implement an endpoint management service, as discussed above, a user of an endpoint has to enroll the endpoint with the endpoint management service. However, in some example cases, the user may not want to enroll all of his or her devices with the endpoint management service of the organization that employs the user. This may be time consuming, and/or the user may not feel comfortable with enrolling all the endpoints with the endpoint management service. This may be particularly relevant if the endpoint is owned by the user, and the user also uses the endpoint for storing and executing personal application programs and personal data. However, the user may still want to execute enterprise application programs in such an un-enrolled endpoint, and may want to access enterprise digital resources from the un-enrolled endpoint. However, such unwillingness of the user to enroll the endpoint with the endpoint management service may prohibit the endpoint management service from directly controlling the un-enrolled endpoint. There may be other example situations where the endpoint management service may be unable to directly control an endpoint. For example, the endpoint management service can be configured to support endpoints having one or more specific types of operating systems, whereas an endpoint can execute a different type of operating system that is not supported by the endpoint management service. Thus, in the above discussed examples, the endpoint management service cannot directly control the endpoint, and is unable to manage the enterprise application programs installed in the endpoint.

Various examples of this disclosure disclose an enhanced endpoint management system, in which an enhanced endpoint management service indirectly manages an endpoint, e.g., manages a first endpoint via a second endpoint. For example, assume that a same user owns and/or uses both the first and second endpoints. The user is willing to enroll the second endpoint with the enhanced endpoint management service, but not the first endpoint. Furthermore, the user wants to execute enterprise application programs in the un-enrolled first endpoint, and also wants to access enterprise digital resources using the un-enrolled first endpoint. In such a situation and in accordance with some examples, the user enrolls the second endpoint with the enhanced endpoint management service. The second endpoint becomes a “directly managed” endpoint. Subsequently, the enhanced endpoint management service uses the second endpoint to manage the first endpoint. Accordingly, the first endpoint becomes an “indirectly managed” endpoint that is managed via the directly managed second endpoint.

In some examples, to indirectly manage an endpoint, the enhanced endpoint management service is configured to allow indirect endpoint management. Assume that the indirectly managed endpoint is a first endpoint, and the directly managed endpoint is a second endpoint. The second endpoint is enrolled as a directly managed endpoint with the enhanced endpoint management service. For example, during the enrollment process, a cross-endpoint parent management service is installed in the second endpoint. The cross-endpoint parent management service of the second endpoint is for controlling and managing the first endpoint. The first endpoint downloads and installs one or more enterprise application programs, but is unable to execute the enterprise application programs without proper authorization from the enhanced endpoint management service. Accordingly, the first endpoint transmits, to the second endpoint, a request for authorization, to enable use of the enterprise application programs. In some examples, the first endpoint transmits, along with the request, information relevant for the authorization (e.g., authentication credentials), and identification of the enterprise application programs to be executed in the first endpoint. Examples of authentication credentials include, but are not limited to, log-in identifier (ID), password, authentication biometrics (e.g., fingerprints, facial features, retina scan, etc.), one-time password, information associated with Multi-Factor Authentication (MFA), and/or the like. The second endpoint forwards the request to the endpoint management service. Thus, the request for authorization is forwarded from the first endpoint to the enhanced endpoint management service via the second endpoint.

The enhanced endpoint management service verifies the authentication credentials, and upon successful verification, authorizes registration of the first endpoint as an indirectly managed endpoint. The enhanced endpoint management service transmits, to the first endpoint and via the second endpoint, authorization information comprising at least one authorization token and one or more policies. The policies, for example, define one or more security parameters, features, resource restrictions, and/or other access controls that are enforced on the enterprise application programs being executed in the first endpoint. The authorization token and the policies are deployed in the first endpoint, and now the first endpoint has the required authorization to allow execution of the enterprise application programs. Accordingly, the first endpoint can now execute the enterprise application programs in the first endpoint, and access various enterprise digital resources.

In some examples, the authorization token is valid for a specific period of time, e.g., 14 days, one month, or another appropriate time period configured by a network/IT administrator of the enterprise. After (or immediately before) the expiration of the authorization token, the above discussed processed is repeated at least in part, to renew the authorization token.

There may be situations when the first endpoint and/or the second endpoint is lost or becomes non-operational. Such a situation may pose a risk to the enterprise, as, for example, the stolen endpoint can be fraudulently used to access the enterprise digital resources. Accordingly, in some examples, the enhanced endpoint management service can invalidate the authorization token assigned to the first endpoint. In some examples, the first endpoint can also delete the authorization token and perform a wipe out process. For example, during the wipe out process, the first endpoint wipes out or deletes any sensitive enterprise data associated with the enterprise application program, and can even uninstall the enterprise application programs, as will be discussed herein in further detail in turn.

Examples of the methods and systems discussed herein are not limited in application to the details of construction and the arrangement of components set forth in the following description or illustrated in the accompanying drawings. The methods and systems are capable of implementation in other examples and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

### Enhanced Endpoint Management System

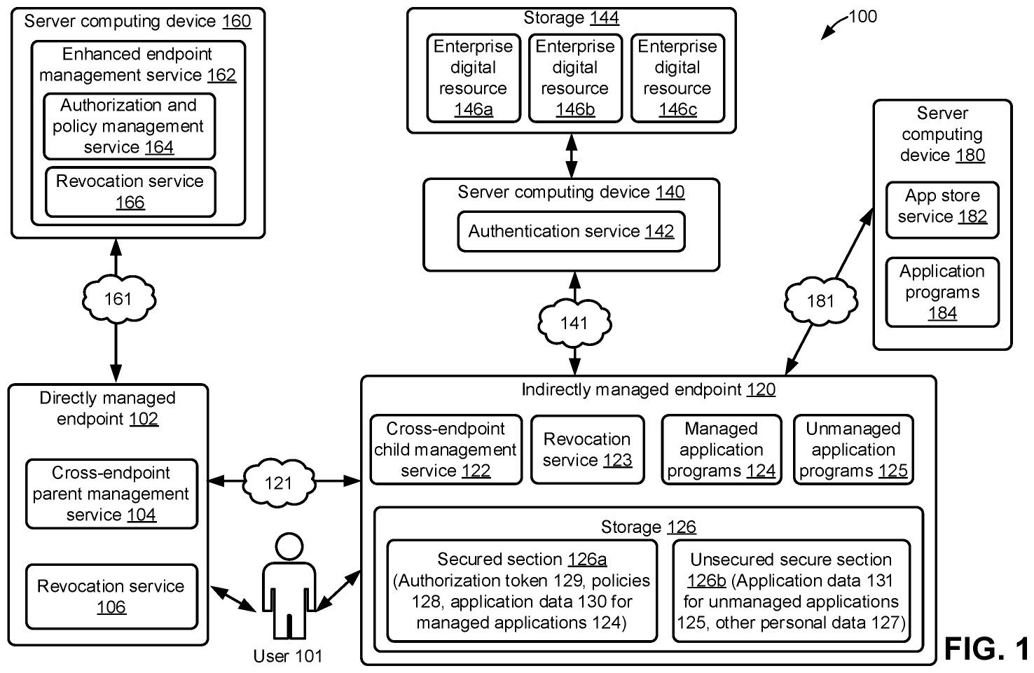

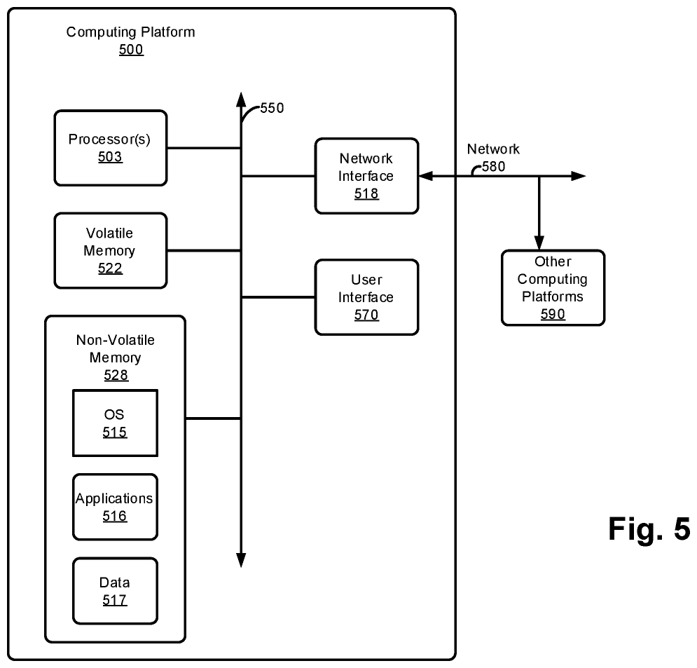

FIG. 1 illustrates an architecture of an enhanced endpoint management system 100 in accordance with some examples. As shown in FIG. 1, the system 100 includes a directly managed endpoint 102, an indirectly managed endpoint 120, server computing devices 140, 160, and 180, and storage 144. Examples of individual ones of the endpoints 102 and 120 and the servers 140, 160, 180 include a computing platform discussed herein later with respect to FIG. 5.

In some examples, the endpoints 102 and 120 are endpoint devices. For example, each of the endpoints 102 and 120 comprises any appropriate user-accessible endpoint computer device, such as a desktop computer, a laptop computer, a smart phone, a tablet, or another appropriate user-accessible endpoint. As previously discussed herein, the term “user-accessible” is used herein, to emphasize that the endpoints 102 and 120 are used by end users, and not by network/IT administrators responsible for enforcing IT security policies across an enterprise. As discussed, the endpoints 102 and 120 are computer devices used by end users, and other devices such as gateway servers, routers, modems, and/or various network devices cannot be deemed as such endpoints.

For example, a user 101 can use the endpoints 102 and 120 to access organizational or enterprise digital resources 146a-c, which may be referred to herein collectively as the enterprise digital resources 146. For example, the user 101 is employed by or otherwise associated with the enterprise, and the user 101 can access sensitive enterprise data (such as enterprise digital resources 146) using the endpoint 120, upon proper authorization of the endpoint 120, as will be discussed in further detail in turn. It should be noted that the digital resources 146 can include stored data, executable code, one or more databases, one or more virtual machines, and/or one or more virtual applications, to name a few examples.

In some examples, the endpoints 102 and 120 are owned by, used by, and/or in possession of a single user, such as the user 101. In an example, the endpoint 102 is owned by the organization or enterprise in which the user 101 is employed and is provided to the user 101 by the organization to access the enterprise digital resources 146, whereas the endpoint 120 is owned by the user 101 and is also used by the user 101 to access the enterprise digital resources 146. In another example, both the endpoints 102 and 120 are owned by the user 101 and are used by the user 101 to access the enterprise digital resources 146.

In some examples, both the endpoints 102 and 120 run on the same computing platform, while in some other examples the endpoints 102 and 120 run on different computing platforms. For example, individual ones of the endpoints 102 and 120 may run the iOS operating system, the Android operating system, the Windows operating system, the Chrome OS operating system, and/or another appropriate operating system suitable for the corresponding endpoint.

In some examples, the endpoint 102 comprises a cross-endpoint parent management service 104 (also referred to herein as parent service 104) and the endpoint 120 comprises a cross-endpoint child management service 122 (also referred to herein as child service 122). Because the endpoints 102 and 120 are used by the same user 101, in some examples, the user 101 can use the same authentication credentials (e.g., same log in identification, password, etc.) to log into both the parent and child services 104 and 122. For example, as will be discussed herein with respect to method 200, the endpoints 102 and 120 communicate to establish remote application management control in the endpoint 120, and during such communication, the same user 101 has to be logged into the parent and child services 104 and 122, using the same authentication credentials.

As will be discussed in further detail herein in turn, an enhanced endpoint management service 162 (also referred to herein as service 162, or as management service 162, discussed herein later) of the system 100 indirectly manages the endpoint 120, e.g., manages the endpoint 120 via the endpoint 102. For example, the child service 122 transmits a request to access enterprise digital resources 146 to the management service 162, via the parent service 104 of the endpoint 102. Upon verification, the management service 162 transmits an authorization token to the child service 122, via the parent service 104. Thus, the management service 162 communicates with the child service 122 of the endpoint 120, via the parent service 104 of the endpoint 102. In contrast, the management service 162 directly manages the endpoint 102, through the parent service 104. As will be discussed in turn in further detail, accordingly, the endpoint 102 is also referred to as a directly managed endpoint, and the endpoint 120 is also referred to as an indirectly managed endpoint.

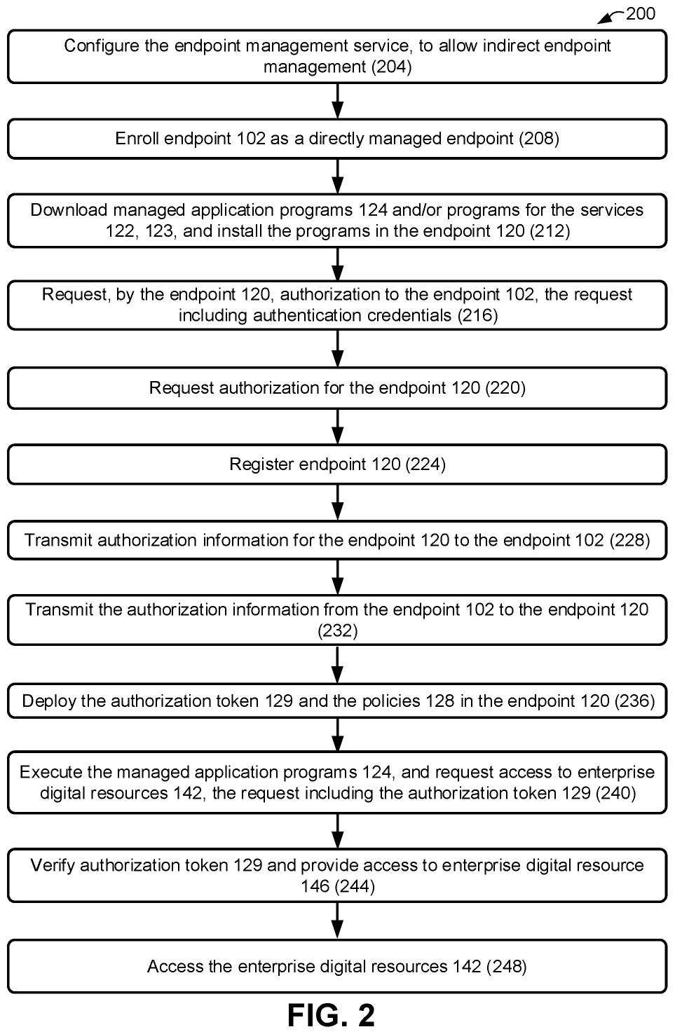

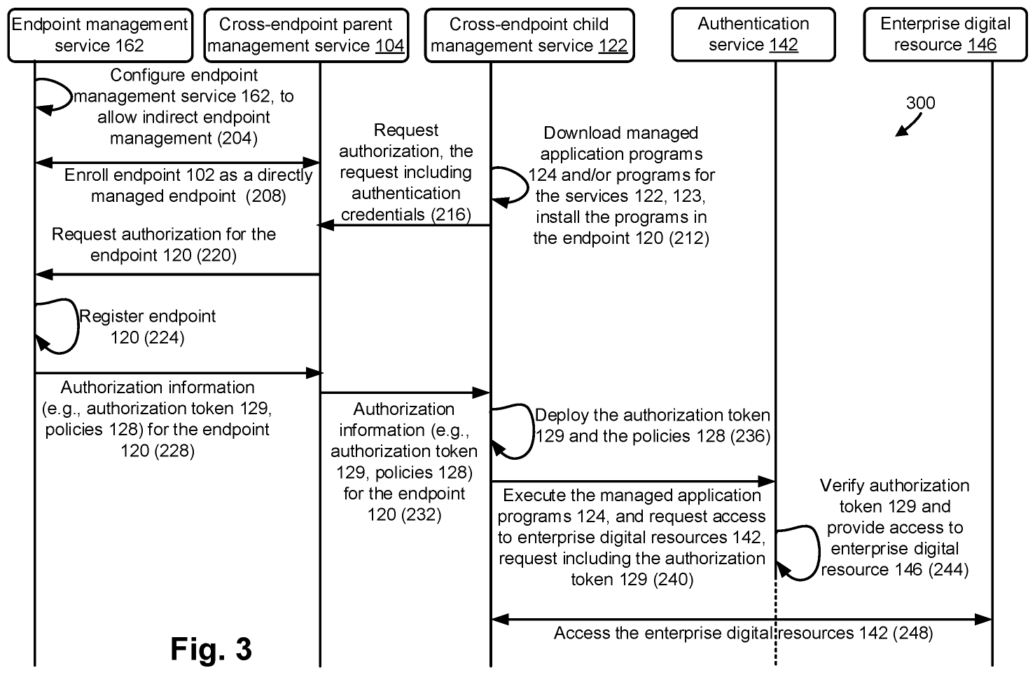

In some examples, the endpoints 102 and 120 communicate over a network 121. In some examples, at least part of the network 121 may include private intranets, corporate networks, local area networks (LAN), personal networks (PAN), Wi-Fi, and/or the like. For example, a PAN network comprising any appropriate short-distance wireless network technology, such as Infrared Data Association (IrDA), wired or wireless Universal Serial Bus (USB), Near-Field-Communication (NFC), Bluetooth, and/or ZigBee, is used for the network 121. In another example, a wireless LAN network comprising Wi-Fi is used for the network 121. In some examples, the communication between the endpoints 102 and 120, which are discussed with respect to the method 200 of FIG. 2 and also illustrated in FIG. 3, occur over such LAN and/or PAN, but not over a Wide Area Network (WAN) such as the Internet. For example, communication between the endpoints 102 and 120 occur when the endpoints 102 and 120 are proximally located, and the same user 101 is authenticated via the endpoints 102 and 120.

In some examples, the endpoint 120 executes the child service 122, a revocation service 123, one or more managed application programs 124, and one or more unmanaged application programs 125. The endpoint 120 further includes a storage 126. The storage 126 comprises a non-volatile storage, such as one or more hard disk drives (HDDs) or other magnetic or optical storage media; one or more solid state drives (SSDs), such as a flash drive or other solid-state storage media; and/or one or more hybrid magnetic and solid-state drives.

In some examples, the storage 126 has a secured section 126a and an unsecured section 126b. The secured section 126a stores enterprise data, over which the enterprise has some or total control. For example, the enterprise data stored within the secured section 126a includes an authorization token 129, one or more policies 128, and application data 130 for the managed application programs 124. In some examples, the unsecured section 126b stores personal user data, such as application data 131 for the unmanaged application programs 125, and other personal user data 127 of the user 101.

Although two sections of the storage 126 are illustrated, in some examples, the storage 126 need not be physically divided in the secured section 126a and the unsecured section 126b. Rather, in some examples, these are two logical or functional partitions of the storage 126. For example, the child service 122 has some or total control over the enterprise data stored in the secured section 126a, and may not have control over the user's personal data stored in the unsecured section 126b.

In some examples, the child service 122 manages policies, to secure the managed application programs 124 being executed on the endpoint 120, as well as to secure the enterprise data stored in the secured section 126a of the storage 126 (such as the application data 130 stored in the secured section 126a). For example, individual ones of one or more managed application programs 124 are executed in accordance with a set of one or more corresponding policies 128 received separately from the managed application programs 124. The policies 128, for example, define one or more security parameters, features, resource restrictions, and/or other access controls that are enforced by the enhanced endpoint management system 100 when the managed application programs 124 are being executed on the endpoint 120. By operating in accordance with their respective policies, each managed application program 124 may be allowed or restricted from communications with one or more other application programs and/or resources, thereby creating a virtual partition. For instance, in an example in which the managed application programs 124 include a mail client, the policies 128 can include data that specifies an address and protocol of a mail server with which the mail client can interoperate. In an example in which the managed application programs 124 include a web browser, the policies 128 can include data that specifies one or more domains to which the browser can navigate. In these examples, the mail client and/or the browser can be restricted to the mail server and domains specified in the policies 128 by operation of the child service 122 and/or operations of the managed application programs 124, themselves.

For example, by enforcing policies on the managed application programs 124, those managed application programs 124 may be restricted to only be able to communicate with other managed application programs and/or trusted enterprise resources, thereby creating a virtual partition that is impenetrable by unmanaged applications and endpoints. This results in a secured and managed environment for the managed application programs 124, in some examples.

In certain examples, the managed application programs 124 are secure application programs. The secure application programs may be email applications, web browsing applications, software-as-a-service (SaaS) applications, native applications, and/or the like. The secure applications may be secure native applications, secure remote applications executed by a secure application launcher, virtualization applications executed by a secure application launcher, and/or the like. In some examples, the virtualization application may store some data and files on the endpoint 120 in a secure storage, such as the secured section 126a of the storage 126, while storing other data and files as a part of enterprise digital resource 146. Thus, an enterprise, for example, may elect to allow certain information to be stored on the endpoint 120 (e.g., in the secured section 126a), while storing other information on the server side as the enterprise digital resources 146.

The unmanaged application programs 125 represent applications owned personally by the user 101, and not owned and/or controlled by the enterprise. For example, the child service 122 may not have any control on the unmanaged application programs 125. Similarly, as discussed, the unsecured section 126b stores application data 131 for unmanaged applications 125 and other personal data 127 of the user 101, and the child service 122 may not have any control on the data stored in the unsecured section 126b.

An enterprise may want to delete from the endpoint 120 selected or all data, files, and/or applications owned, licensed or controlled by the enterprise (e.g., the enterprise data), such as the enterprise data within the secured section 126a. Such selective or total deletion of enterprise data in the secured section 126a is also referred to as a wipe out process. For example, the child service 122 has control over the enterprise data stored in the secured section 126a, and can choose to perform a selective wipe, as will be discussed in detail in turn. Thus, the enterprise, via the child service 122, has control over the managed application programs 124 and associated data stored in the secured section 126a. The child service 122, while executing the selective wiping of the enterprise data in the secured section 126a, however, cannot wipe out or delete the personal data of the user 101 stored in the unsecured section 126b.

In some examples, the system 100 comprises the server computing device 140 (also referred to herein as server 140) executing an authentication service 142. The server 140 is coupled to a storage 144. The storage 144 can include one or more HDDs or other magnetic or optical storage media; one or more SSDs, such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

The storage 144 includes one or more enterprise digital resources 146, represented symbolically as enterprise digital resources 146a, 146b, 146c. Access to the storage 144 is controlled by the server 140. For example, the server 140 including the authentication service 142 is a gateway that controls access to the enterprise digital resources 146a, 146b, 146c. For example, the gateway service implementing the authentication service 142 can allow the endpoint 120 selective access to the enterprise digital resources 146a, 146b, 146c, after proper verification and authentication of the endpoint 120. Examples of such gateway services include Citrix® NetScaler® gateway, or a Citrix Gateway As A Service® that are commercially available from Citrix Systems of Fort Lauderdale, Fla. in the United States.

The enterprise digital resources 146 include any appropriate digital resource owned and/or maintained by an organization or enterprise, to which the user 101 is associated with or employed by. For example, the enterprise digital resources 146 may include data associated with email servers, file sharing servers, SaaS applications, Web application servers, Windows application servers, and/or the like. The enterprise digital resources 146 can be premise-based resources, cloud-based resources, or a combination of both. In an example, the enterprise digital resources 146 are accessed by the endpoint 120 through the server 140. In another example, the enterprise digital resources 146 are accessed by the endpoint 120, after the endpoint 120 is authenticated by the authentication service 142 being executed within the server 140. In some examples, the enterprise digital resources 146 can be accessed by the managed application programs 124 of the endpoint 120, and cannot be accessed by the unmanaged application programs 125. The child service 122 can control, based on the policies 128, whether a managed application program 124 can access a specific enterprise digital resource 146. Thus, the child service 122 controls, based on the policies 128, accessing of the enterprise digital resources 146 by the various managed application programs 124.

In some examples, the managed application programs 124 can access the server 140 and/or the enterprise digital resources 146 via a network 141. In some examples, one or more sections of the network 141 are a WAN, such as the Internet. In some examples, at least part of the network 141 may include private intranets, corporate networks, LAN, MAN, wireless networks, PAN, and/or the like.

In some examples, the system 100 comprises the server computing device 160 (also referred to herein as server 160) executing the enhanced endpoint management service 162, also referred to herein as service 162, or as management service 162. An example of the management service 162 include the Citrix® Endpoint Management® that is commercially available from Citrix Systems of Fort Lauderdale, Fla. in the United States. As will be discussed in further detail herein, the management service 162 provides enterprise level endpoint management solutions for the endpoints 102 and/or 120. The management service 162 provides an authorization and policy management service 164 and a revocation service 166, as will be discussed herein later.

In some examples, the endpoint 102 can access the server 160 via a network 161. In some examples, one or more sections of the network 161 are a WAN, such as the Internet. In some examples, at least part of the network 161 may include private intranets, corporate networks, LAN, MAN, wireless networks, PAN, and/or the like.

Although the endpoint 102 and the server 160 communicate over the network 161, in some examples, the server 160 may not communicate directly with the endpoint 120. For example, communication between the server 160 and the endpoint 120 is via the endpoint 102. For example, the management service 162 communicates with the child service 122 of the endpoint 120, via the parent service 104 of the endpoint 102.

For example, as discussed, the user 101 owns or otherwise uses multiple endpoints, such as the endpoints 102 and 120. The user 101 desires to access enterprise digital resource 146 using each of the endpoints 102 and 120, and possibly one or more other endpoints that the user 101 uses. The user 101 enrolls the endpoint 102 with the enterprise (e.g., with the management service 162), such that enterprise management software is downloaded and executed in the endpoint 102. Thus, the enterprise (such as the management service 162) can directly manage and control the endpoint 102.

However, in some example cases, the user 101 may not want to enroll each of his or her endpoints with the management service 162. This may be time consuming, and/or the user may not feel comfortable to enroll all her endpoints, such as the endpoint 120, with the management service 162. This may be particularly relevant if the endpoint 120 is owned by the user 101 (e.g., the endpoint is a BYOD device, or Bring your own device), and the user 101 also uses the endpoint 120 for storing and executing personal application programs (such as the unmanaged application programs 125) and personal data. However, the user 101 may still want to execute the managed application programs 124 in such a BYOD device, and want to access enterprise digital resource 146b from the endpoints. Such user preferences (e.g., unwillingness to register the endpoint 120 with the management service 162) may prohibit the management service 162 from directly controlling the endpoint 120 (e.g., directly controlling the managed application programs 124 installed in the endpoint 120).

There may be other example situations where the management service 162 may be unable to directly control the endpoint 120 (e.g., directly control the managed application programs 124). For example, the management service 162 can be configured to support endpoints having one or more specific types of operating systems, whereas the endpoint 120 can execute a different type of operating system that is not supported by the management service 162. For example, the management service 162 can be configured to support iOS and/or android systems, whereas the endpoint 120 can have Chrome OS. This may prohibit the management service 162 from directly controlling the endpoint 120 (e.g., directly control the managed application programs 124 installed in the endpoint 120).

In yet other example, the endpoint 120 may not be able to access a WLAN network, such as the Internet. For example, many wearable endpoints can access nearby endpoints using Bluetooth or NFC connection, but may not be able to directly access the Internet. This may prohibit the management service 162 from directly controlling the endpoint 120.

Thus, in the above discussed examples, the management service 162 cannot directly control the endpoint 120, and manage the managed application programs 124 installed in the endpoint 120. In some such cases, in some examples, the management service 162 controls the endpoint 120 via the endpoint 102 (e.g., via the parent service 104). Thus, the endpoint 102 acts as a bridge between the management service 162 and the endpoint 120, so that the endpoint 120 does not have to enroll directly with the management service 162. Rather, the user 101 enrolls the endpoint 120 with the user's own endpoint 102. The management service 162 can control and manage the endpoint 102 (e.g., control and manage the parent service 104 of the endpoint 102), which in turn can control and manage the endpoint 120. Thus, the endpoint 120 is indirectly managed by the management service 162, via the endpoint 102.

In some examples, the system 100 comprises the server computing device 180 (also referred to herein as server 180) executing an application store service 182 (also referred to herein as service 182). For example, the service 182 can host different application programs 184, some of which may be enterprise applications. The enterprise applications of the application programs 184 can be provided originally by the service provider, or developed by the enterprise using a management software development kit (SDK). The SDK provides the enterprise the capability to secure an application, by wrapping the application. The secure application wrapper, in some examples, include integrated policies that are executed on an endpoint when the secure native application is executed on the endpoint. The wrapped and secure application programs 184 are downloaded in the endpoint 120 as managed application programs 124, e.g., by the user 101, where the child service 122 manages and controls the managed application programs 124. The application programs 184 also includes other applications (e.g., which are not secured by wrapping), and the user can download such unwrapped applications as the unmanaged application programs 125.

In some examples, the endpoint 102 can access the server 180 via a network 181. In some examples, one or more sections of the network 181 are a WAN, such as the Internet. In some other examples, at least part of the network 181 may include private intranets, corporate networks, LAN, MAN, wireless networks, PAN, and/or the like.

### Enhanced Endpoint Management Processes

FIG. 2 illustrates an example of an endpoint management process 200 executed by an enhanced endpoint management system, such as the system 100 of FIG. 1. FIG. 3 is a sequence diagram 300 that illustrates an enhanced endpoint management process executed by an enhanced endpoint management system, such as the system 100 of FIG. 1. As shown in FIGS. 2 and 3, the operations in the process 200 and the sequence diagram 300 are executed by the management service 162 within the server 160 of FIG. 1, the parent service 104 within the endpoint 102 of FIG. 1, the child service 122 within the endpoint 120 of FIG. 1, and the authentication service 142 within the server 140 of FIG. 1. The process 200 and the sequence diagram 300 are discussed in unison.

Referring to the process 200 of FIG. 2, at 204, the management service 162 is configured to allow indirect endpoint management by the management service 162, as also illustrated in FIG. 3. For example, an IT administrator of the enterprise can update the management service 162, such that the management service 162 is now capable of indirectly managing one or more endpoints, such as the endpoint 120. The management service 162, in some examples, functions in a MAM mode, where the management service 162 provides application level MAM control of endpoints. In some other examples, the management service 162 functions in an MDM mode, where the management service 162 provides endpoint level MDM control of endpoints. In some other examples, the management service 162 functions in an MDM+MAM mode, where the management service 162 provides endpoint level MDM control of some endpoints and application level MAM control of some other endpoints.

In the example use case of FIG. 1 where the management service 162 directly manages the endpoint 102 and indirectly manages the endpoint 120, the management service 162 provides, for example, application level MAM control of the indirectly managed endpoint 120. The management service 162 can provide either application level MAM control or endpoint level MDM control of the directly managed endpoint 102, in some examples.

In some examples, during the configuration of the management service 162, one or more application programs (e.g., application programs for deploying the parent service 104 and/or the child service 122) are also uploaded to the server 160. Similarly, the policies 128 are also deployed to the server 160 during the configuration of the management service 162.

The method 200 then proceeds from 204 to 208. At 208, the endpoint 102 is enrolled as a directly managed endpoint, as also illustrated in FIG. 3. For example, during the enrollment process, the parent service 104 in the endpoint 102 is deployed, configured and/or authenticated by the management service 162. The parent service 104 is for controlling and managing the endpoint 120. Although not illustrated, the management service 162 may also deploy one or more services for managing and controlling the endpoint 102—but such deployment is not illustrated in the figures so as to not obfuscate the teachings of this disclosure.

The method 200 then proceeds from 208 to 212. At 212, the endpoint 120 downloads one or more of the managed application programs 124 and/or programs for the child service 122 and the revocation service 123, and installs the programs in the endpoint 120, as also illustrated in FIG. 3. For example, the user 101 initiates the download at 212. In some examples, subsequent to enrolling the endpoint 102 with the management service 162, the endpoint 102 can display QR code (Quick Response code), and the user 101 scans the QR code using the endpoint 120, which initiates the download process in the endpoint 120. In some other examples, scanning the QR code provides, in the endpoint 120, an option to download one or more managed application programs 124 and/or the programs for the child service 122 and the revocation service 123 in the endpoint 120 from the application store 182, and the user 101 can choose to download and install. In some examples, instead of, or in addition to, the QR codes, the endpoint 102 can also display weblinks and/or other relevant information associated with downloading the managed application programs 124 and/or programs for the child service 122 and the revocation service 123.

Although method 200 illustrates the block 212 subsequent to the blocks 204 and 208, operations of the block 212 can occur at least in part prior to or simultaneously with operations of the blocks 204 and/or 208. For example, the download process at 212 is not directly corelated with the configuration and/or enrollment process at 204 and 208, respectively. Although after the enrollment process at 208, the endpoint 102 can aid in the download process of 212 (e.g., by displaying the QR codes, for example), the user 101 can choose to initiate the download process of 212 prior to, concurrently with, and/or subsequent to the configuration and/or enrollment process at 204 and 208, respectively.

The method 200 then proceeds from 212 to 216. At 216, the endpoint 120 transmits, to the endpoint 102, a request for authorization to enable use of the managed application programs 124, as also illustrated in FIG. 3. For example, the user launches a managed application program 124 in the endpoint 120. The managed application program 124 requires authorization to execute (e.g., requires authorization to access the enterprise digital resources 146). Accordingly, the endpoint 120 establishes a connection with the directly managed endpoint 102, to request authorization to enable and use the managed application programs 124. In some examples, the endpoint 120 transmits, along with the request, information relevant for the authorization (e.g., authentication credentials), and identification of the managed application programs 124 to be executed in the endpoint 120. For example, the endpoint 120 transmits, along with the request, one or more types of authentication credentials, such as log-in ID, password, authentication fingerprints, one-time password, information associated with MFA, and/or the like, so that the endpoint 120 and/or the management service 162 can authenticate the user 101 via the endpoint 120, thereby associating the endpoint 120 with the user 101.

The method 200 then proceeds from 216 to 220. At 220, the endpoint 102 transmits a request to the management service 162, to provide authorization to the endpoint 120, as also illustrated in FIG. 3. In some examples, the endpoint 102 transmits, along with this request, the authentication credentials and the identification of the managed application programs 124, which the endpoint 102 received from the endpoint 120 at 216. However, in some other examples, the request from the endpoint 102 to the management service 162 does not include the authentication credentials, as the endpoint 102 may have already verified the authenticity of the authentication credentials.

The method 200 then proceeds from 220 to 224. At 224, the management service 162 verifies the authentication credentials, and upon successful verification, registers the endpoint 120 as an indirectly managed endpoint, as also illustrated in FIG. 3. In some examples, the management service 162, upon successful verification, also registers the managed application programs 124 to be executed in the endpoint 120.

The method 200 then proceeds from 224 to 228. At 228, the management service 162 transmits, to the endpoint 102, authorization information intended for the endpoint 120, as also illustrated in FIG. 3. In some examples, the authorization information includes the authorization token 129, the policies 128, and/or other relevant information that is needed by the managed application programs 124 from the management service 162 to successfully execute and access the enterprise digital resources 146. Although operations at 224 and 228 are illustrated in FIGS. 2 and 3 as separate blocks, in some examples, the management service 162 can execute the operations at 224 and 228 at least partially simultaneously, or can execute the operations at 228 prior to the operations at 224.

The method 200 then proceeds from 228 to 232. At 232, the endpoint 102 transmits the authorization information (e.g., the authorization token 129 and the policies 128), which it received from the management service 162, to the endpoint 120, as also illustrated in FIG. 3. Thus, the endpoint 102 forwards the authorization information from the management service 162 to the endpoint 120.

The method 200 then proceeds from 232 to 236. At 236, the authorization token 129 and the policies 128 are deployed in the endpoint 120, as also illustrated in FIG. 3. As a result, now the child service 122 has the required authorization to allow execution of the managed application programs 124, and allow the managed application programs 124 to access the enterprise digital resources 146.

The method 200 then proceeds from 236 to 240. At 240, the endpoint 120 executes the managed application programs 124, and the managed application programs 124 request access to the enterprise digital resources 146, as also illustrated in FIG. 3. In some examples, the request includes the authorization token 129. Access to the enterprise digital resources 146 can be controlled, in some examples, by the authentication service 142. FIG. 3 illustrates the access request being transmitted to the authentication service 142.

The method 200 then proceeds from 240 to 244. At 244, the authentication service 142 verifies the authorization token 129, and upon successful verification, provides the managed application programs 124 access to the enterprise digital resource 146, as also illustrated in FIG. 3.

The method 200 then proceeds from 244 to 248. At 248, the managed application programs 124 within the endpoint 120 access the enterprise digital resources 146, as also illustrated in FIG. 3. The access can be through the authentication service 142, or directly by bypassing the authentication service 142. Accordingly, to reflect both the possible manner in which the managed application programs 124 within the endpoint 120 can access the enterprise digital resources 146, a part of the vertical line corresponding to the authentication service 142 is illustrated by a dotted line in FIG. 3. The dotted section in FIG. 3 implies that the accessing of the enterprise digital resources 146 may be through the authentication service 142, or by bypassing the authentication service 142.

In some examples, the authorization token 129 is valid for a specific period of time, e.g., 14 days, one month, or another appropriate time period configured by a network/IT administrator of the enterprise. After (or immediately before) the expiration of the authorization token 129, the authorization token 129 can be renewed using one or more operations discussed with respect to method 200.

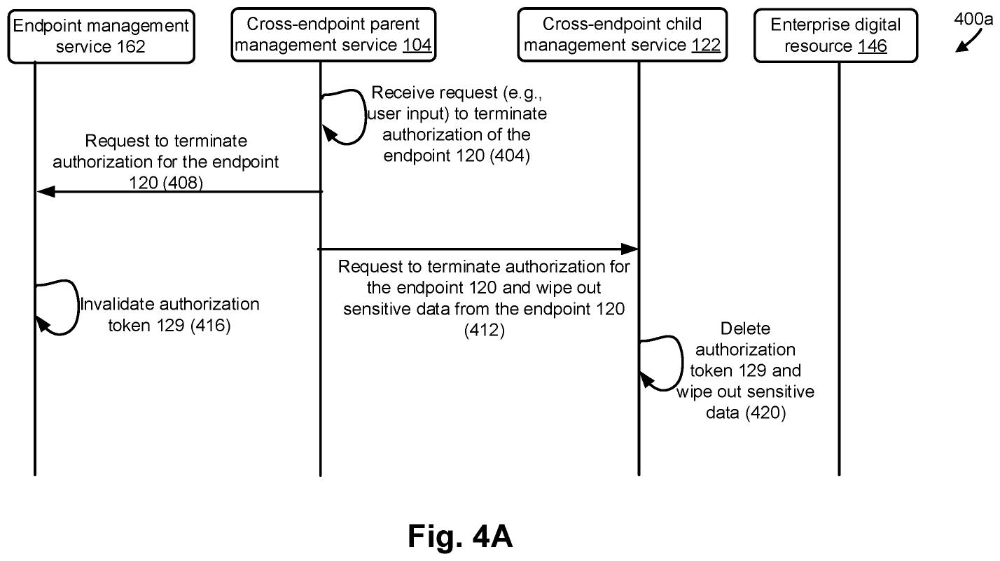

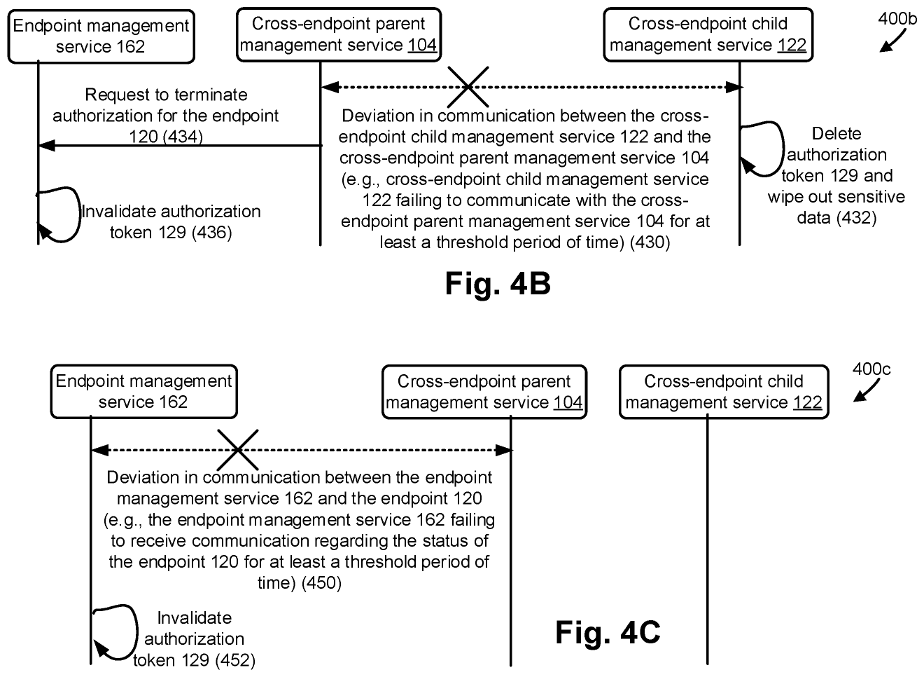

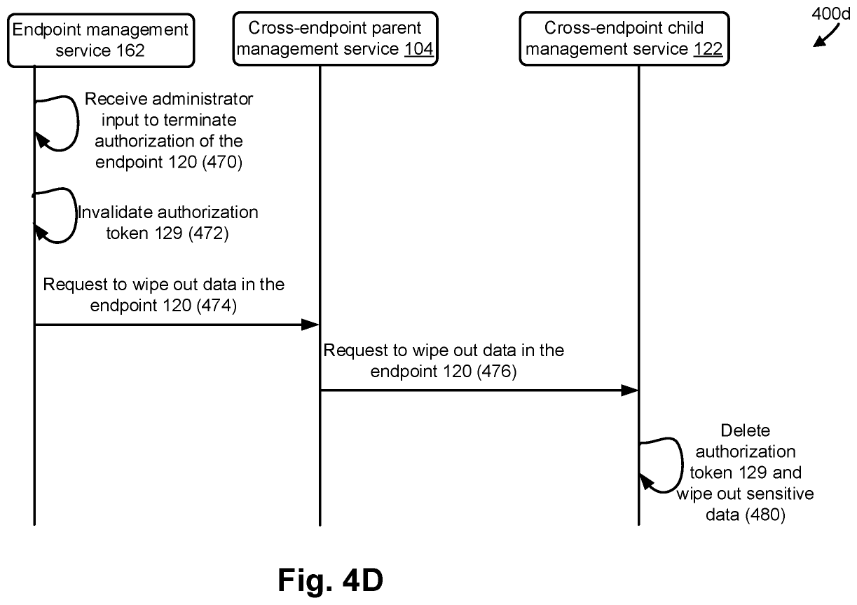

FIGS. 4A-4D are sequence diagrams that illustrate example authorization revocation processes executed by an enhanced endpoint management system, in accordance with an example of the present disclosure. For example, as discussed with respect to FIGS. 2 and 3, the endpoint 120 and the managed application programs 124 are authorized to access the enterprise digital resource 146b. FIGS. 4A-4D illustrate various example scenarios where the authorization is revoked and/or data within the secured section 126a of the storage 126 are wiped out.

Referring to FIG. 4A, illustrated is a sequence diagram 400a. At 404, the parent service 104 being executed in the directly managed endpoint 102 receives a request to terminate authorization of the endpoint 120. For example, the user 101 provides a user input to the endpoint 102, to terminate or revoke the authorization. The user 101, in some examples, inputs such a request via an appropriate input device, such as using a mouse, a touch sensitive display, a keyboard, using gestures, and/or verbal command. For example, the user 101 may have lost the endpoint 120, and accordingly, may request the endpoint 102 to terminate authorization of the endpoint 120 to access the enterprise digital resources 146. In another example, the user 101 may simply want to not use the managed application programs 124 in the endpoint 120, and accordingly, may request the endpoint 102 to terminate authorization of the endpoint 120 to access the enterprise digital resources 146.

Subsequent to 404, at 408, the endpoint 102 (e.g., the parent service 104) transmits a request to terminate authorization of the endpoint 120 to the management service 162 and/or to invalidate the authorization token 129 assigned to the endpoint 120. At 412, the endpoint 102 (e.g., the parent service 104) also transmits the request to terminate authorization of the endpoint 120 to the child service 122 of the endpoint 120, e.g., by invalidating and/or deleting the authorization token 129 assigned to the endpoint 120 and performing a wipe out operation.

At 416, the management service 162 and/or the revocation service 166 invalidates the authorization token 129 assigned to the endpoint 120. Thus, the managed application programs 124 in the endpoint 120 can no longer access the enterprise digital resources 146. Also, at 420, the child service 122 and/or the revocation service 123 causes deletion of authorization token 129 and performs a wipe out of the endpoint 120. For example, sensitive enterprise data, such as the data stored in the secured section 126, are wiped out (e.g., deleted and/or zeroed/overwritten). Thus, the authorization token 129, policies 128, and/or application data 130 for managed applications 124 are wiped out, in some examples. In some examples, the managed applications 124 may optionally be uninstalled as well. During the wipe out process, the child service 122 does not wipe out or delete the personal data of the user 101 stored in the unsecured section 126b. Thus, now the endpoint 120 does not have any sensitive enterprise data, and cannot access the enterprise digital resources 146.

Referring now to FIG. 4B, illustrated is a sequence diagram 400b depicting another example scenario where the endpoint 120 performs a wipe out process. For example, at 430, there is a deviation in communication between the child service 122 of the endpoint 120 and the parent service 104 of the endpoint 102. For example, the child service 122 fails to communicate with the parent service 104 for at least a threshold period of time. The threshold period may be user configurable and/or configured by the network/IT administrator of the enterprise, and may have a default value. Merely as an example, the threshold period can be 2 hours, 3 days, 5 days, 10 days, 14 days, or another appropriate time period. The failure to communicate can be, merely as an example, because the user 101 has lost the endpoint 102 and/or the endpoint 120, and/or the endpoint 102 and/or the endpoint 120 is non-operational. Accordingly, this may jeopardize the security of enterprise data and managed application programs 124 in the endpoint 120.

The failure of the child service 122 to communicate with the parent service 104 is a mere example of a deviation in communication between these two services. There may be other examples of deviation in communication between the child service 122 and the parent service 104. Communications between the child service 122 and the parent service 104 not occurring at a pre-agreed time is another example of a deviation in communication. In yet another example, failing by either or both the two services to transmit a pre-agreed security code periodically and/or during any communications can be yet another example of such deviation. Other deviations are also possible.

In response to detecting the deviation, at 432, the child service 122 and/or the revocation service 123 of the endpoint 120 cause deletion of the authorization token 129 and perform a wipe out process, e.g., as discussed with respect to 420 of FIG. 4A.

At 434, in response to detecting the deviation, the parent service 104 and/or the revocation service 106 of the endpoint 102 also transmits, to the management service 162, a request to terminate authorization for the endpoint 120, e.g., as discussed with respect to 408 of FIG. 4A. At 436, the management service 162 and/or the revocation service 166 invalidates the authorization token 129 assigned to the endpoint 120, e.g., as discussed with respect to 416 of FIG. 4A. Thus, the managed application programs 124 in the endpoint 120 can no longer access the enterprise digital resources 146.

Referring now to FIG. 4C, illustrated is a sequence diagram 400c depicting an example scenario where the management service 162 revokes authorization of the endpoint 120. For example, at 450, there is a deviation in communication between the endpoint management service 162 and the endpoint 120. Merely as an example, the management service 162 fails to receive communication regarding the status of the endpoint 120 for at least a threshold period of time, where examples of the threshold period have been discussed with respect to 430 of FIG. 4B. The failure to communicate can be, merely as an example, because the user 101 has lost the endpoint 120 and/or the endpoint 120 is non-operational. Other examples of deviation have been discussed with respect to FIG. 4B.

At 452, the management service 162 and/or the revocation service 166 invalidate the authorization token 129 assigned to the endpoint 120, e.g., as discussed with respect to 416 of FIG. 4A. Thus, the managed application programs 124 in the endpoint 120 can no longer access the enterprise digital resources 146.

Referring to FIG. 4D, illustrated is a sequence diagram 400d depicting another example scenario where the management service 162 revokes authorization of the endpoint 120. At 470, the management service 162 receives input from the network/IT administrator to terminate authorization of the endpoint 120. This may be because the user 101 is no longer employed by the enterprise, or because the administrator deems the endpoint 120 to be a security threat to, or in violation of, organizational security, and/or any other appropriate reason.

At 472, the management service 162 and/or the revocation service 166 invalidate the authorization token 129 assigned to the endpoint 120, e.g., as discussed with respect to 416 of FIG. 4A. Thus, the managed application programs 124 in the endpoint 120 can no longer access the enterprise digital resources 146.

At 474, the management service 162 and/or the revocation service 166 transmit, to the endpoint 102 (e.g., the parent service 104) a request to wipe out data in the endpoint 120. At 476, the parent service 104 forwards the request to the child service 122. At 480, the child service 122 and/or the revocation service 123 of the endpoint 120 cause deletion of the authorization token 129 and perform a wipe out process, e.g., as discussed with respect to 420 of FIG. 4A.

### Computing Platform for Enhanced Endpoint Management Systems

FIG. 5 is a block diagram of a computing platform 500 configured to implement various enhanced endpoint management systems and processes in accordance with examples disclosed herein.

The computing platform 500 includes one or more processor(s) 503, volatile memory 522 (e.g., random access memory (RAM)), non-volatile memory 528, a user interface (UI) 570, one or more network or communication interfaces 518, and a communications bus 550. The computing platform 500 may also be referred to as a computing device, an endpoint, a computer, or a computer system.

The non-volatile (non-transitory) memory 528 can include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

The user interface 570 can include a graphical user interface (GUI) (e.g., controls presented on a touchscreen, a display, etc.) and one or more input/output (I/O) devices (e.g., a mouse, a keyboard, a microphone, one or more speakers, one or more cameras, one or more biometric scanners, one or more environmental sensors, and one or more accelerometers, one or more visors, etc.) and/or a software stack to drive such devices.

The non-volatile memory 528 stores an operating system 515, one or more applications or programs 516, and data 517. The operating system 515 and the application 516 include sequences of instructions that are encoded for execution by processor(s) 503. Execution of these instructions results in manipulated data. Prior to their execution, the instructions can be copied to the volatile memory 522. In some examples, the volatile memory 522 can include one or more types of RAM and/or a cache memory that can offer a faster response time than a main memory. Data can be entered through the user interface 570 or received from the other I/O device(s), such as the network interface 518. The various elements of the platform 500 described above can communicate with one another via the communications bus 550.

The illustrated computing platform 500 is shown merely as an example computing device, an example endpoint computing device, an example endpoint, an example server computing device, and/or a gateway computing device, as discussed with respect to the system 100 of FIG. 1, and can be implemented within any computing or processing environment with any type of physical or virtual machine or set of physical and virtual machines that can have suitable hardware and/or software capable of operating as described herein.

The processor(s) 503 can be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations can be hard coded into the circuitry or soft coded by way of instructions held in a memory device and executed by the circuitry. A processor can perform the function, operation, or sequence of operations using digital values and/or using analog signals.

In some examples, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multicore processors, or general-purpose computers with associated memory. In some examples, a processor can be configured to perform one or more operations by being coupled to a memory storing instructions executable by the processor to perform the one or more operations.

The processor(s) 503 can be analog, digital or mixed. In some examples, the processor(s) 503 can be one or more local or remote physical processors. A processor including multiple processor cores and/or multiple processors can provide functionality for parallel, simultaneous execution of instructions or for parallel, simultaneous execution of one instruction on more than one piece of data.

The network interfaces 518 can include one or more interfaces to enable the computing platform 500 to access a computer network 580 such as a Local Area Network (LAN), a Wide Area Network (WAN), a Personal Area Network (PAN), or the Internet through a variety of wired and/or wireless connections, including cellular connections and Bluetooth connections. For example, the network interfaces 518 can be used to access the networks of the system 100 of FIG. 1. In some examples, the network 580 may allow for communication with other computing platforms 590, to enable distributed computing.

In described examples, the computing platform 500 can execute managed application programs in an endpoint, subsequent to receiving an authorization from an enhanced endpoint management service. As discussed, the authorization can be received from the enhanced endpoint management service via another endpoint that is being executed in another instance of the computing platform 500. The computing platform 500 can be used to execute the enhanced endpoint management service.

Having thus described several aspects of at least one example, it is to be appreciated that various alterations, modifications, and improvements will readily occur to those skilled in the art. For instance, examples disclosed herein can also be used in other contexts. Such alterations, modifications, and improvements are intended to be part of this disclosure and are intended to be within the scope of the examples discussed herein. Accordingly, the foregoing description and drawings are by way of example only.

Also, the phraseology and terminology used herein is for the purpose of description and should not be regarded as limiting. Any references to examples, components, elements or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” can be construed as inclusive so that any terms described using “or” can indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

1. A computer system comprising:
a second endpoint configured to communicate with a first endpoint distinct from the second endpoint, the second endpoint comprising
a network interface,
a memory, and
one or more processors coupled to the memory and the network interface, the one or more processors configured to
receive, from an endpoint management service via the network interface, authorization information authorizing the first endpoint to access digital resources controlled by the endpoint management service, and
transmit the authorization information to the first endpoint to enable the first endpoint to access the digital resources based on the authorization information.

2. The computer system of claim 1, wherein:
the authorization information includes
an authorization token usable by the first endpoint to access the digital resources, and
one or more policies dictating one or more corresponding rules associated with accessing the digital resources.

3. The computer system of claim 2, wherein the one or more processors are further configured to:
receive a user input to prevent the first endpoint from accessing the digital resources; and
in response to the user input, transmit one or more of
a first request to the endpoint management service, requesting the endpoint management service to mark the authorization token as being invalid, thereby preventing the first endpoint from accessing the digital resources, or
a second request to the first endpoint, requesting the first endpoint to delete the authorization token and/or to wipe out application data associated with one or more application programs installed in the first endpoint.

4. The computer system of claim 2, wherein the one or more processors are further configured to:
identify a deviation in communications between the second endpoint and the first endpoint; and
in response to identification of the deviation, request the endpoint management service to mark the authorization token as being invalid, thereby preventing the first endpoint from accessing the digital resources.

5. The computer system of claim 1, wherein the one or more processors are further configured to:
transmit the authorization information to the first endpoint over a personal area network or a local area network.

6. The computer system of claim 1, wherein the one or more processors are further configured to:
receive, from the first endpoint, an indication that an application program has been installed in the first endpoint, and a first request for the authorization information, the first request comprising authentication credentials that includes one or both of a user identifier or a password; and
transmit, to the endpoint management service, a second request for the authorization information, the second request including the authentication credentials,
wherein the second endpoint receives the authorization information from the endpoint management service in response to the second request.

7. The computer system of claim 1, wherein the network interface is a first network interface, the memory is a first memory, the one or more processors are first one or more processors, and wherein the computer system further comprises:
the first endpoint comprising:
a second network interface;
a second memory; and
one or more second processors coupled to the second memory and the second network interface, the one or more second processors being configured to
install an application program in the first endpoint,
transmit, to the second endpoint, a request for the authorization information, to enable the application program to access the digital resources,
receive, from the second endpoint, the authorization information, and
execute the application program, and access, using the application program, the digital resources, based on the authorization information.

8. The computer system of claim 7, wherein:
the authorization information includes an authorization token usable by the first endpoint to access the digital resources, and one or more policies dictating one or more corresponding rules associated with accessing the digital resources; and
the one or more second processors are further configured to
store the authorization token and the one or more policies in the second memory, and
in response to a deviation in communication with the second endpoint and/or in response to a request from the second endpoint, delete the authorization token and/or wipe out application data associated with the application program.

9. A first endpoint comprising:
a network interface;
a memory; and
one or more processors coupled to the memory and the network interface, the one or more processors configured to
install an application program in the first endpoint;
request, to an endpoint management service via a second endpoint, for an authorization token;
receive, from the endpoint management service via the second endpoint, the authorization token; and
execute the application program, in response to receiving the authorization token.

10. The first endpoint of claim 9, wherein:
the one or more processors are further configured to execute a first cross-endpoint management service that processes the authorization token;
the authorization token is received from a second cross-endpoint management service being executed in the second endpoint; and
during reception of the authorization token, a same user credential is used to log into both of the first cross-endpoint management service and the second cross-endpoint management service.

11. The first endpoint of claim 9, wherein the first endpoint transmits the request for the authorization token to the second endpoint and receives the authorization token from the second endpoint over a personal area network or a local area network.

12. The first endpoint of claim 9, wherein the one or more processors are further configured to:
transmit another request to an authentication service to access enterprise digital resources, the other request including the authorization token; and
in response to the authentication service successfully verifying the authorization token, receive authorization to access the enterprise digital resources.

13. The first endpoint of claim 9, further comprising:
a non-volatile storage logically partitioned in a first section and a second section,
wherein application data associated with the application program and the authorization token are stored in the first section,
wherein personal user data are stored in the second section, and
wherein the one or more processors are further configured to
receive, from the second endpoint, instructions to revoke authorization to execute the application program, wherein the instructions to revoke originates either (i) in the endpoint management service and transmitted via the second endpoint, or (ii) in the second endpoint, and
in response to the instructions to revoke, delete the authorization token and/or wipe out the application data from the first section of the non-volatile storage, without deleting any personal user data from the second section of the non-volatile storage.

14. The first endpoint of claim 9, further comprising:
a non-volatile storage logically partitioned in a first section and a second section,
wherein application data associated with the application program and the authorization token are stored in the first section,
wherein personal user data are stored in the second section, and
wherein the one or more processors are further configured to
detect a failure of the first endpoint to communicate with the second endpoint for at least a threshold period of time, and
in response to the failure to communicate for at least the threshold period of time, delete the authorization token and/or wipe out the application data from the first section of the non-volatile storage, without deleting any personal user data from the second section of the non-volatile storage.

15. A method comprising:
receiving, by a second endpoint and from an endpoint management service, an authorization token intended for a first endpoint; and
transmitting, by a second cross-endpoint management service being executed in the second endpoint, the authorization token to a first cross-endpoint management service being executed in the first endpoint, to facilitate the first endpoint to access digital resources based on the authorization token,
wherein during transmission of the authorization token, a same user credential is used to log into both of the first cross-endpoint management service and the second cross-endpoint management service.

16. The method of claim 15, further comprising:
receiving, from the first endpoint, a request for authorization, the request including authorization credentials; and
transmitting the request, along with the authorization credentials, to the endpoint management service,
wherein the authorization token is received by the second endpoint from the endpoint management service, in response to transmitting the request to the endpoint management service.

17. The method of claim 15, further comprising:
receiving a user input to revoke authorization of the first endpoint to access the digital resources; and
in response to the user input, transmitting by the second endpoint and to the endpoint management service, a request to revoke the authorization of the first endpoint.

18. The method of claim 17, further comprising:
in response to the user input, transmitting by the second endpoint and to the first endpoint, another request to delete the authorization token and/or to perform a wipe out process at the first endpoint.

19. The method of claim 15, further comprising:
identifying, by the second cross-endpoint management service of the second endpoint, a deviation in communications with the first cross-endpoint management service of the first endpoint; and
in response to identifying the deviation in communications, transmitting, by the second endpoint and to the endpoint management service, a request to revoke the authorization of the first endpoint.

20. The method of claim 15, further comprising:
receiving, by the second endpoint, a request from the endpoint management service, to revoke authorization of the first endpoint to access the digital resources; and
in response to the request, transmitting, by the second endpoint and to the first endpoint, another request to delete the authorization token and/or to perform a wipe out process at the first endpoint.
